(19) United States
(12) Patent Application Publication
(10) Pub. No.: US 2011/0304471 A1
(43) Pub. Date: Dec. 15, 2011

(54) MULTI-FUNCTIONAL INFRARED THERMOMETER

(76) Inventors: Hsin-Chen Ko, Taipei (TW); Win-Throng Chen, Taipei County (TW)

(21) Appl. No.: 12/797,108

(22) Filed: Jun. 9, 2010

(51) Int. Cl. G08B 21/00; G01J 5/00

(52) U.S. Cl. 340/664; 374/121

(57) ABSTRACT

A multi-functional infrared thermometer having an infrared sensor device, a sensing device and a light-emitting diode (LED) light source is provided, wherein the infrared sensor device and the sensing device are disposed in a shell and used for measuring a temperature and an electric field state of a subject to be tested respectively; a control module is disposed in the shell and includes a power source device and a control circuit board for electrically connecting the control module to the infrared sensor device, the sensing device, and the LED light source, so as to detect the temperature and the electric field state of the subject to be tested and display detection results on a display device, and to provide an illumination.

### FIELD OF THE INVENTION

The present invention relates to a multi-functional infrared thermometer, particularly, to a multi-functional infrared thermometer capable of detecting a temperature or a power state of a subject to be tested while maintaining a distance from the subject to be tested, and also having an illumination function.

### DESCRIPTION OF THE PRIOR ART

In recent years, infrared thermometers have been widely applied, which receives infrared rays emitted from a surface of a subject to be tested through a sensing element and converts the infrared rays into an electronic signal to perform temperature measurement, such that the thermometer determines the surface temperature of the subject to be tested without contacting the subject to be tested, which thus has advantages of safety, rapid detection, and a long service life. Therefore, the infrared thermometers are often used to detect the temperature of high-temperature, hazardous, or unreachable devices, especially large units or high-voltage electrical devices that are likely to generate high temperature, in which the infrared thermometers are used to perform protective security check through detecting the thermal state changes of the devices.

Before performing maintenance on the electrical devices, besides measuring the temperature, it further requires to perform power detection at positions of the circuit by using an electric meter to determine whether the circuit is still powered on, so as to protect the staff from being accidentally electrocuted. Meanwhile, as the operation environment is always in a dark condition, the staff has to prepare a variety of instruments, which are inconvenient for users in operation and inconvenient for carrying along.

In view of the above, in order to eliminate the disadvantages, the inventor sets forth the present invention on the basis of years of experience and continuous research and development, as well as making improvements persistently.

### SUMMARY OF THE INVENTION

The primary object of the present invention is to provide a multi-functional infrared thermometer having a sensing device disposed in a shell and used for receiving an electric field. The sensing device triggers an alarm to transmit a warning message when the multi-functional infrared thermometer approaches a subject to be tested in a powered-on state, so as to rapidly detect a power state of the subject to be tested, and enhance the convenience of the maintenance work.

Another object of the present invention is to provide to a multi-functional infrared thermometer having a light-emitting diode (LED) light source disposed at a front end of a shell, to enhance the convenience of the maintenance work in an environment with dim light.

In order to achieve the objects described above, the multi-functional infrared thermometer according to the present invention comprises a shell, an infrared sensor device, a sensing device, and a control module. The infrared sensor device and the sensing device are disposed in the shell and used for measuring a temperature and an electric field state of a subject to be tested respectively. The control module is disposed in the shell and includes a power source device and a control circuit board for electrically connecting the control module to the infrared sensor device and the sensing device, so as to detect the temperature and the electric field state of the subject to be tested and to display detection results on a display device.

In practice, the sensing device includes a detector.

In practice, the shell has a laser pointing device disposed at a front end thereof, for emitting a spot to indicate a position where the infrared sensor device measures the temperature.

In practice, the shell further has an LED light source disposed at a front end thereof, and the LED light source is electrically connected to the control module.

In practice, the shell further has a detector for warning disposed therein, in which the detector is triggered by the control module when an electric field is detected.

Other objects, advantages and novel features of the present invention will become more apparent from the following detailed description when taken in conjunction with the accompanying drawings.

### BRIEF DESCRIPTION OF THE DRAWINGS

FIG. 1 is a perspective view of a multi-functional infrared thermometer according to an embodiment of the present invention.

FIG. 2 is a schematic view of an architecture of the embodiment shown in FIG. 1.

FIG. 3 is a front outside view of the embodiment shown in FIG. 1.

FIG. 4 is a top outside view of the embodiment shown in FIG. 1.

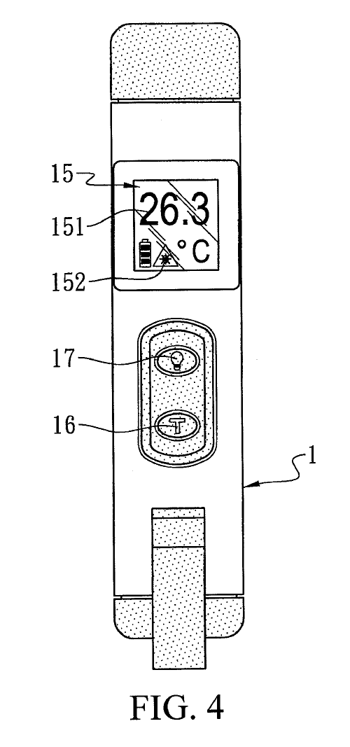

### DETAILED DESCRIPTION

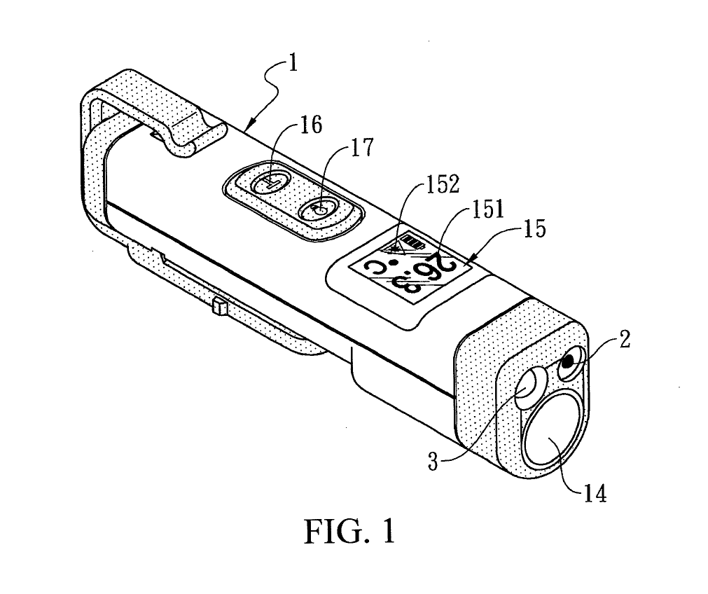

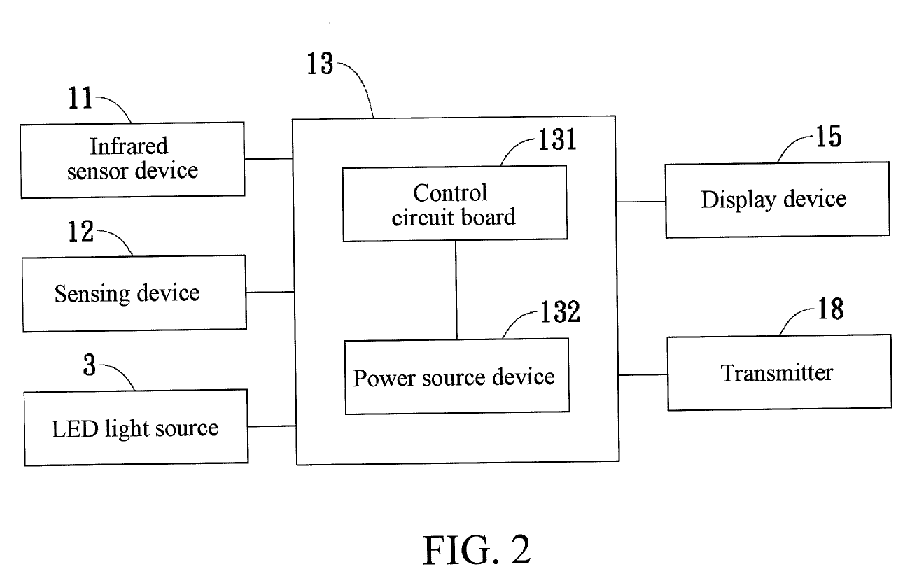

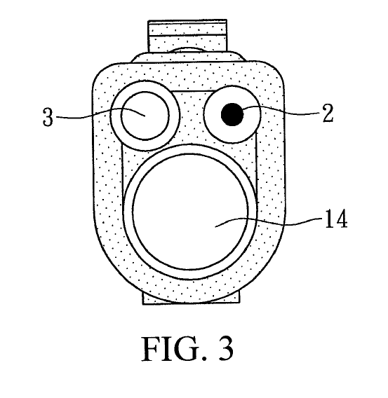

Referring to FIG. 1, it shows an embodiment of a multi-functional infrared thermometer of the present invention. The multi-functional infrared thermometer includes a shell 1, having an infrared sensor device 11, a sensing device 12, and a control module 13 (as shown in FIG. 2) disposed therein, and having a filter 14, a pointing device 2, and an LED light source 3 (as shown in FIG. 3) disposed at a front end thereof.

The infrared sensor device 11 receives infrared rays emitted by a surface of a subject to be tested through the filter 14 at the front end of the shell 1 and converts the received infrared rays into an electronic signal, for measuring a heat source temperature. The sensing device 12 includes a detector (not shown) for receiving an electric field generated by the subject to be tested.

The control module 13 includes a control circuit board 131 and a power source device 132 for providing a power source for the above elements, so as to electrically connect the control module 13 to the infrared sensor device 11 and the sensing device 12. The control circuit board 131 is electrically connected to the pointing device 2, a display device 15 disposed on the LED light source 3 and the shell, a measurement switch 16, and a illumination switch 17. The pointing device 2 emits a laser spot, and when the measurement switch 16 is pressed, the control circuit board 131 controls the pointing device 2 to emit a laser spot to a temperature measurement position on the surface of the subject to be tested and enables the infrared sensor device 11 and the sensing device 12 to measure the heat source temperature and the voltage and electric field of the subject to be tested. Thus, the control circuit board 131 performs conversion calculation on the measurement signals from the infrared sensor device 11 and the sensing device 12, and then displays a temperature value 151 and an electricity message 152 on the display device 15 according to the converted temperature and electric field intensity. Furthermore, by pressing the illumination switch 17, the control circuit board 131 enables the LED light source 3 to provide an auxiliary lighting function, and then by pressing the illumination switch 17 again, the LED light source 3 is turned off

In practice, the shell 1 further has an alarm 18 for warning disposed therein, for example, a speaker or an indicator (not shown) disposed on the surface of the shell, and the alarm 18 is electrically connected to the control circuit board 131. The alarm 18 is triggered to transmit a warning sound or a flickering signal by the control module 13 when an electric field is detected, so as to notify the operator that the subject to be tested is still powered on.

In practice, the filter 14 is made of a material having a low infrared emissivity, for example, polypropylene (PP) and polyethylene (PE).

In practice, the power source device 132 is powered by a battery.

In practice, the display device 15 is a liquid crystal display (LCD) screen or any other suitable display.

Therefore, the present invention has the following advantages:

1. The present invention improves the conventional temperature and circuit detection mode, so that the operator can measure the surface temperature and the power state of the subject to be tested conveniently while maintaining a safe pitch away from the subject to be tested, thereby saving the detection motions and the detection time, ensuring the operators' safety, as well as improving the convenience.

2. The present invention integrates an infrared thermometer, a non-contact voltage detector, and an LED flashlight into one design, which is easily carried along and used, and conveniently operated in a dim environment, so as to improve the practicability.

To sum up, according to the above disclosed content, the present invention can surely achieve the anticipated objects of the present invention, in which the multi-functional infrared thermometer capable of detecting a temperature and a power state of a subject to be tested while keeping a certain distance from the subject to be tested to ensure the operators' safety and improve the convenience in usage is provided, which has high industrial applicability, such that the present application is filed for a present invention patent according to the law.

It should be understood that different modifications and variations could be made from the disclosures of the present invention by the people familiar in the art without departing the spirit of the present invention.

What is claimed is:

1. A multi-functional infrared thermometer, comprising:
a shell, having an infrared sensor device disposed therein, for measuring a temperature of a subject to be tested;
a sensing device, disposed in the shell, for receiving an electric field generated by the subject to be tested; and
a control module, disposed in the shell, and comprising a power source device and a control circuit board, for electrically connecting the control module to the infrared sensor device and the sensing device, so as to detect the temperature and electric field of the subject to be tested and display detection results on a display device.

2. The multi-functional infrared thermometer according to claim 1, wherein the shell further has a pointing device disposed at a front end thereof, for emitting a spot to indicate a position where the infrared sensor device measures the temperature.

3. The multi-functional infrared thermometer according to claim 1, wherein the shell further has a light-emitting diode (LED) light source disposed at a front end thereof, and the LED light source is electrically connected to the control module.

4. The multi-functional infrared thermometer according to claim 1, wherein the shell further has an alarm for warning disposed therein and the alarm is triggered by the control module when an electric field is detected.

5. The multi-functional infrared thermometer according to claim 5, wherein the alarm is an indicator or a speaker.
